(19) United States
(12) Patent Application Publication
(10) Pub. No.: US 2011/0039222 A1
(43) Pub. Date: Feb. 17, 2011

(54) Firing Table for a Furnace

(75) Inventor: Stephan Miller, Traunstein (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: DEKEMA Dental-Keramikoefen GmbH, Freilassing (DE)

(21) Appl. No.: 12/919,424

(22) PCT Filed: Feb. 25, 2009
(86) PCT No.: PCT/EP2009/001343

§ 371 Date: Oct. 26, 2010

(30) Foreign Application Priority Data
Mar. 3, 2008 (DE) 202008002982.1

(51) Int. Cl. F27D 5/00

(52) U.S. Cl. 432/258

(57) ABSTRACT

The invention relates to a combustion table for an oven for dental ceramics made of solid, highly temperature-resistant material, having a base, a top side, and a wall, wherein the combustion table is formed of at least two parts in order to improve the temperature resistance of the combustion table.

The present invention relates to a firing table for a furnace made from solid refractory material having a lower side, an upper side and a wall.

Such firing tables, which are used, for example in furnaces for dental ceramics, have the problem that the table can be destroyed by high temperature gradients. There is furthermore the problem that the firing table shrinks due to the high temperatures. This effect is amplified by the kiln furniture arranged on the firing table and by the kiln feed since they have a high weight.

It is the underlying object of the invention to provide an improved firing table which does not have these disadvantages.

This object is satisfied in that the firing table is formed from at least two parts.

The construction of the firing table from two or more parts has the advantage that temperature strains can be dissipated better. On a division of the firing table parallel to the upper side and lower side, the temperature gradient is smaller in each case from the top to the bottom in both parts than with a single-part firing table. These parts can thereby be produced from mechanically differently stable, e.g. differently porous materials, adapted to the environmental temperatures. Any cracking thereby occurs considerably more rarely.

On a division of the firing table perpendicular to the upper side and lower side, the temperature strains are likewise reduced since the parts are each per se smaller than a single-part firing table. They thereby have the possibility independently of one another to expand or shrink dependent on the temperature.

The parts of the firing table can also be made from different materials. A use of a material harder with respect to the surrounding materials is preferably provided at the lower side of the firing table. This harder material serves for the support of the firing table. The surrounding softer material is thereby protected against destruction. The refractory material of firing tables is namely usually relatively soft. It is in this respect, for example, less dense, porous aluminum oxide. The use can comprise material which is less refractory, but in contrast harder, for example calcium oxide, since lower temperatures are present in the lower region of the firing table.

In accordance with a further preferred embodiment, the firing table has support bars of material harder with respect to the surrounding material and extending from the lower side to the upper side. The support bars advantageously serve for the support of kiln furniture so that its weight and the weight of the firing material arranged on the kiln furniture is taken up by the bars of harder material. The softer material is thereby in turn protected. The support bars can, for example, be made of densely sintered aluminum oxide. To protect these bars with respect to high temperatures, they are preferably embedded in cut-outs of the softer material.

The firing table furthermore preferably has a shoulder which contacts an insulation of the furnace with a closed furnace. A particularly good insulation of the interior of the furnace is hereby achieved.

In accordance with a further embodiment of the invention, the firing table has a further shoulder for the support of a ring-shaped piece of kiln furniture. The ring is thereby particularly safely supported. The height of the ring is preferably larger than the height of the shoulder so that there is a spacing between the upper side of the ring and the firing table. A thermal decoupling thereby results between the upper side of the ring and the firing table. A plate or a crucible is usually placed onto the upper side of the ring and the firing material is then arranged thereon. The firing material is thus also thermally decoupled with respect to the firing table.

There is preferably a shape-matched connection between the parts of the firing table. The lower part of the firing table can, for example, have a central cut-out in the upper side into which the upper part of the firing table is inserted. The lower part itself can furthermore be made of two parts which are connected to one another by a dovetail connection. The support bars are also preferably inserted into cut-outs of the firing table in shape-matched form. A stable construction of the firing table results from such shape-matched connections.

The invention furthermore relates to a piece of kiln furniture for a furnace for dental ceramics which is made in ring shape. The upper side of the ring in this respect has a plurality of cut-outs, particularly preferably four cut-outs. The inner space of the ring is thermally coupled to the furnace by the cut-outs. Four turrets onto which a further piece of kiln furniture can be placed, such as a plate or a further ring, arise by the provision of four cut-outs. When four or more turrets are provided, the upper kiln furniture also remains supported in a stable manner on a breaking away of a turret.

Embodiments of the invention are shown in the drawings and will be described in the following. There are shown in a schematic representation in each case:

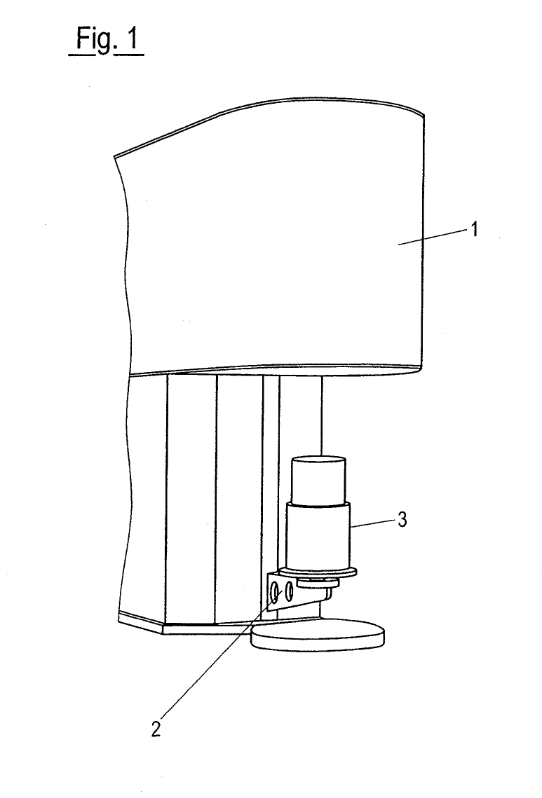

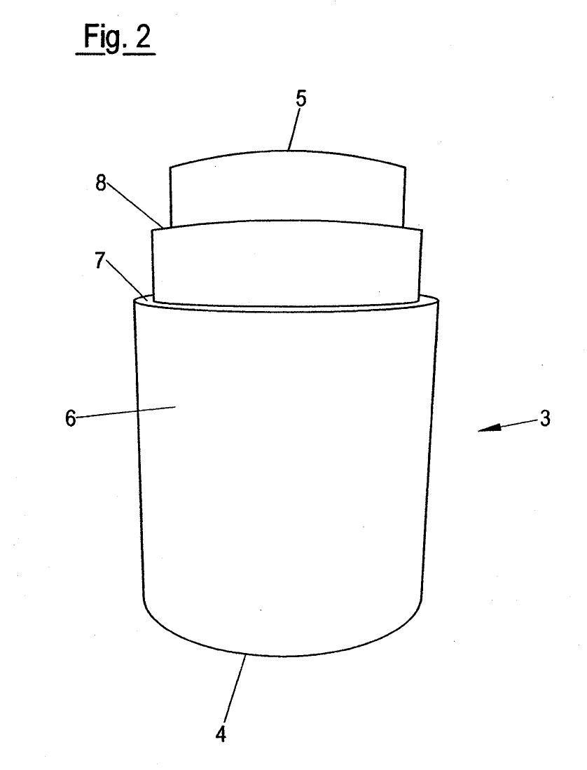

FIG. 1 a furnace with a moved-out firing table; FIG. 2 a firing table in accordance with the invention;

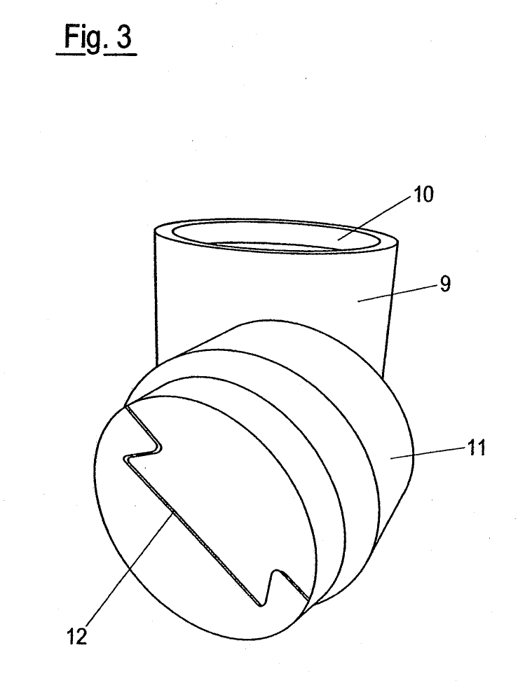

FIG. 3 the firing table of FIG. 2, partly disassembled;

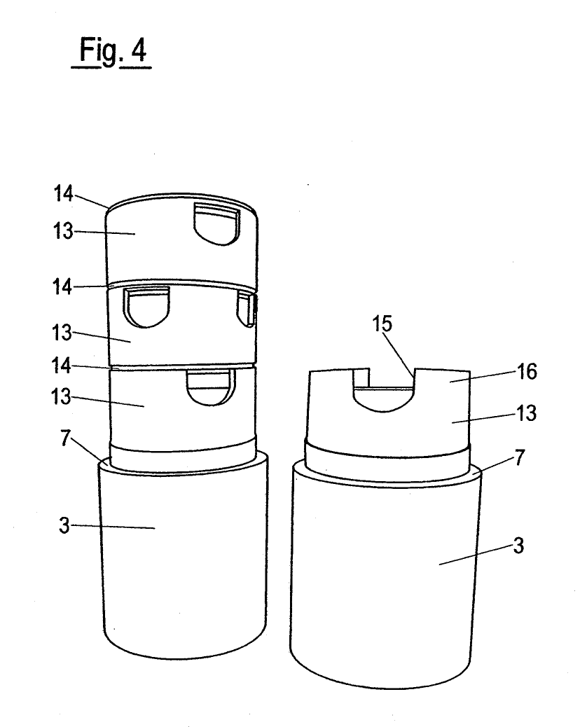

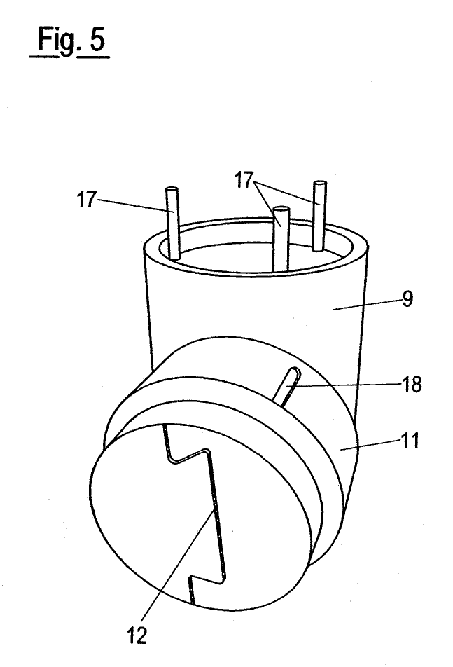

FIG. 4 two firing tables with kiln furniture; FIG. 5 a disassembled firing table with support bars;

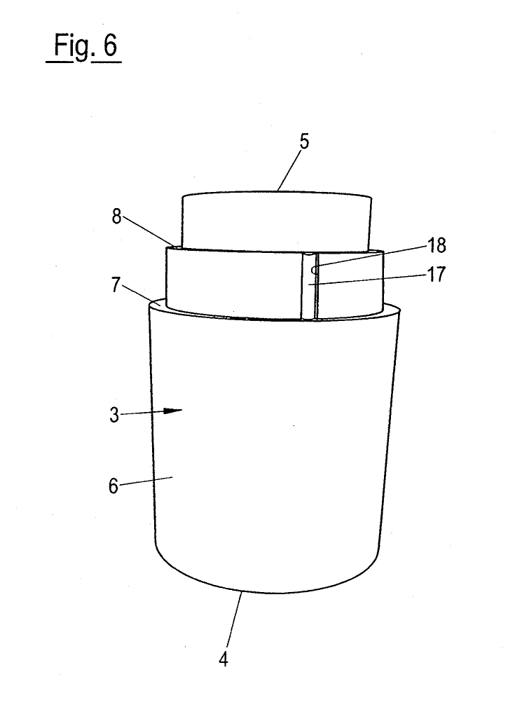

FIG. 6 the firing table of FIG. 5 in an assembled state; and

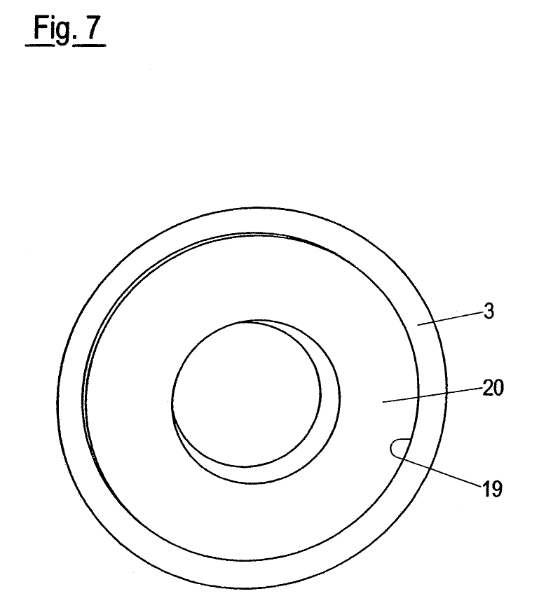

FIG. 7 the lower side of a firing table in accordance with the invention.

The furnace shown in FIG. 1 includes a housing 1 in which a firing chamber is arranged. A firing table 3 can be moved into the firing chamber via a lift 2. The firing material, optionally with kiln furniture, is arranged on the firing table 3.

The firing table 3 shown in FIG. 2 includes a lower side 4, an upper side 5 and a wall 6. The firing table 3 has a first shoulder 7 which contacts the insulation of the furnace 1 with a moved in firing table. The firing table 3 furthermore has a second shoulder 8 on which a ring-shaped piece of kiln furniture can be supported.

As shown in FIG. 3, the firing table 3 has a lower part 9 which is provided with a cut-out 10 on its upper side. The upper part 11 of the firing table 3 can be inserted into the cut-out 10. The upper part 11 is likewise made in two parts, with the division extending perpendicular to the upper side 5 of the firing table. The dividing line 12 is made in dovetail shape.

FIG. 4 shows how kiln furniture can be placed onto the upper shoulder 8 of the firing table 3. The kiln furniture includes rings 13 and plates 14, with the rings 13 being provided with U-shaped cut-outs 15 at their upper rims. Each ring 13 has four cut-outs 15 distributed evenly over the periphery so that four turrets 16 are formed on which the plates 14 are supported. As can be recognized in FIG. 4, the width of the rings 13 is selected to be so large that there is a spacing between the plate 14 and the upper side 5 of the firing table 3.

FIG. 5 shows a firing table 3 with three support bars 17. The support bars 17 are made up of a material which is harder than the remaining firing table material. The support bars 17 are inserted into cut-outs 18 of the upper part 11 and serve for the support of the kiln furniture 13. As can be recognized in FIG. 6, the length of the support bars 17 is selected such that their upper ends terminate flush with the shoulder 8 of the firing table 3.

FIG. 7 shows the lower side 4 of a firing table 3. This lower side is provided with a cut-out 19 into which a ring-shaped insert 20 is inserted. The insert 20, like the bars 17, is made of a material which is harder than the surrounding firing table material. The firing table 3 is supported toward the bottom via the insert 20, that is in particular on the lift 2.

The firing table 3 in accordance with the invention can also have more than three parts. In particular porous aluminum oxide can be considered as the material for the firing table. The harder parts such as the insert 20 and the support bars 17 are preferably made of calcium oxide or of densely sintered aluminum oxide. The rings 13 can also be made with three turrets or with more turrets instead of with four turrets 16. As shown in FIG. 4, a plurality of pieces of kiln furniture 13, 14 can be arranged on the firing table 3. In particular up to three firing rings 13 and three plates 14 are provided. Crucibles can also be used on the first ring 15 instead of plates and rings. These crucibles can also have corresponding cut-outs, analog to the firing rings 13.

### Reference Numeral List

1 furnace housing

2 lift

3 firing table

4 lower side of 3

5 upper side of 3

6 wall of 3

7 first shoulder

8 second shoulder

9 lower part of 3

10 cut-out in 9

11 upper part of 3

12 dividing line

13 ring

14 plate

15 cut-out

16 turret

17 support bar

18 cut-out

19 cut-out

20 support ring

1-10. (canceled)

11. A firing table for a furnace for dental ceramics made from solid refractory material having a lower side (4), an upper side (5) and a wall (6),
characterized in that
the firing table (3) is made of at least two parts (9, 11).

12. A firing table in accordance with claim 11, characterized in that the firing table (3) is divided parallel to the upper and lower sides (4, 5).

13. A firing table in accordance with claim 11, characterized in that the firing table (3) is divided perpendicular to the upper and lower sides (4, 5).

14. A firing table in accordance with claim 11, characterized in that the firing table (3) is made from at least two different materials, in particular porous materials.

15. A firing table in accordance with claim 11, characterized in that the firing table (3) has an insert (20) of material harder with respect to the surrounding material on its lower side (4).

16. A firing table in accordance with claim 11, characterized in that the firing table (3) has support bars (17) of material harder with respect to the surrounding material and extending from the lower side (4) to the upper side (5).

17. A firing table in accordance with claim 11, characterized in that the firing table (3) has a shoulder (7) which contacts an insulation of the furnace with a closed furnace.

18. A firing table in accordance with claim 11, characterized in that the firing table (3) has a shoulder (8) for the support of a ring-shaped piece of kiln furniture (13).

19. A firing table in accordance with claim 11, characterized in that a shape-matched connection is present between the parts (10, 11) of the firing table (3).

20. Kiln furniture for a furnace for dental ceramics, characterized in that the piece of kiln furniture (13) is made in ring shape, with a rim of the ring (13) having cut-outs (15), in particular four cut-outs (15).
